(19) United States
(12) Patent Application Publication
(10) Pub. No.: US 2022/0207996 A1
(43) Pub. Date: Jun. 30, 2022

(54) METHOD, APPARATUS, AND SYSTEM FOR REAL-TIME TRAFFIC BASED LOCATION REFERENCING WITH OFFSETS FOR ROAD INCIDENT REPORTING

(71) Applicant: HERE Global B.V., Eindhoven (NL)

(72) Inventors: Jingwei XU, Buffalo Grove, IL (US); Yuxin GUAN, Chicago, IL (US); Bruce BERNHARDT, Wauconda, IL (US)

(21) Appl. No.: 17/553,075

(22) Filed: Dec. 16, 2021

Related U.S. Application Data
(60) Provisional application No. 63/132,277, filed on Dec. 30, 2020.

(51) Int. Cl. G08G 1/01

(52) U.S. Cl. CPC G08G 1/0133

(57) ABSTRACT

An approach is provided for providing traffic based location referencing with offsets for road incident reporting. The approach, for example, involves determining a road incident that crosses at least one boundary between a first road segment and a second road segment. The approach also involves creating an aggregated road segment comprising a start location of the road incident in the first road segment to the boundary and from the boundary to an end location of the road incident in the second road segment or an end road segment. The approach further involves providing a report of the road incident that is referenced to a positive offset from the start location of the road incident to a beginning of the first road segment and/or a negative offset from the end location of the road incident to an end of the second road segment or the end road segment.

### RELATED APPLICATION

This application claims priority to U.S. Provisional Patent Application Ser. No. 63/132,277, filed Dec. 30, 2020, entitled “METHOD, APPARATUS, AND SYSTEM FOR REAL-TIME TRAFFIC BASED LOCATION REFERENCING WITH OFFSETS FOR ROAD INCIDENT REPORTING”, which is incorporated herein by reference in its entirety.

### BACKGROUND

Navigation and mapping service providers are continually challenged to provide digital maps with road incident reports to support advanced applications such as autonomous driving. For example, providing users and/or vehicle up-to-date data on traffic flow and road incidents (e.g., accidents, road work areas, etc.) can potentially reduce congestion and improve safety. However, road incident information is reported in various location referencing schemes that come with different advantages and disadvantages to support autonomous driving, etc. Therefore, service providers face significant technical challenges to improve the location referencing schemes for better road incident reporting accuracy and efficiency that support autonomous driving, etc.

### SOME EXAMPLE EMBODIMENTS

Therefore, there is a need for providing traffic based location referencing with offsets for road incident reporting.

According to one embodiment, a method comprises determining a road incident that crosses at least one boundary between a first road segment and a second road segment. The method also comprises creating an aggregated road segment comprising a start location of the road incident in the first road segment to the boundary and from the boundary to an end location of the road incident in the second road segment or an end road segment. The method further comprises providing a report of the road incident that is referenced to a positive offset from the start location of the road incident to a beginning of the first road segment, a negative offset from the end location of the road incident to an end of the second road segment or the end road segment, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine a road incident that crosses at least one boundary between a first road segment and a second road segment. The apparatus is also caused to create an aggregated road segment comprising a start location of the road incident in the first road segment to the boundary and from the boundary to an end location of the road incident in the second road segment or an end road segment. The apparatus is further caused to provide a report of the road incident that is referenced to a positive offset from the start location of the road incident to a beginning of the first road segment, a negative offset from the end location of the road incident to an end of the second road segment or the end road segment, or a combination thereof.

According to another embodiment, a computer-readable storage medium carries one or more sequences of one or more instructions which, when executed by one or more processors, cause, at least in part, an apparatus to determine a road incident that crosses at least one boundary between a first road segment and a second road segment. The apparatus is also caused to create an aggregated road segment comprising a start location of the road incident in the first road segment to the boundary and from the boundary to an end location of the road incident in the second road segment or an end road segment. The apparatus is further caused to provide a report of the road incident that is referenced to a positive offset from the start location of the road incident to a beginning of the first road segment, a negative offset from the end location of the road incident to an end of the second road segment or the end road segment, or a combination thereof.

According to another embodiment, an apparatus comprises means for determining a road incident that crosses at least one boundary between a first road segment and a second road segment. The apparatus also comprises means for creating an aggregated road segment comprising a start location of the road incident in the first road segment to the boundary and from the boundary to an end location of the road incident in the second road segment or an end road segment. The apparatus further comprises means for providing a report of the road incident that is referenced to a positive offset from the start location of the road incident to a beginning of the first road segment, a negative offset from the end location of the road incident to an end of the second road segment or the end road segment, or a combination thereof.

A road incident can extend from the first road segment, via the second road segment, . . . , and into the end road segment, e.g., there may be zero or more road segments between the first road segment and the end road segment. The aggregation across those intermediate segments occurs as described below can reference with accuracy using (1) a positive offset from a start location of the road incident to a beginning of the first road segment, and (2) a negative offset from an end location of the road incident to an end of the end road segment.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing traffic based location referencing with offsets for road incident reporting, according to one embodiment;

FIG. 2A are diagrams of example aggregated road segments, according to various embodiment;

FIG. 2B a diagram of an example data flow for providing traffic based location referencing with offsets for road incident reporting, according to one embodiment;

FIG. 2C is a diagram of an example process for providing traffic based location referencing using aggregated road segments, according to one embodiment;

FIG. 3 is a diagram of components of a traffic platform capable of providing traffic based location referencing with offsets for road incident reporting, according to one embodiment;

FIG. 4 is a flowchart of a process for providing traffic based location referencing using aggregated road segments, according to one embodiment;

FIG. 5 is a flowchart of a process for generating example location reference points (LRPs), according to various embodiments;

FIG. 6 is a diagram of an example scenario of traffic aggregation and location reference generation, according to one embodiment;

FIG. 7 is a diagram of an example scenario of traffic aggregation and location reference generation involving intermediate location reference point(s), according to one embodiment;

FIG. 8 is a diagram of an example scenario of traffic aggregation and location reference generation involving intermediate location reference point(s) at a lane-level, according to one embodiment;

FIG. 9 is a diagram of an example user interface utilized real-time traffic based location referencing with offsets, according to one or more example embodiments;

FIG. 10 is a diagram of a geographic database, according to one embodiment;

FIG. 11 is a diagram of hardware that can be used to implement an embodiment;

FIG. 12 is a diagram of a chip set that can be used to implement an embodiment; and

FIG. 13 is a diagram of a mobile terminal (e.g., handset or vehicle or part thereof) that can be used to implement an embodiment.

### DESCRIPTION OF SOME EMBODIMENTS

Examples of a method, apparatus, and computer program for providing traffic based location referencing with offsets for road incident reporting are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

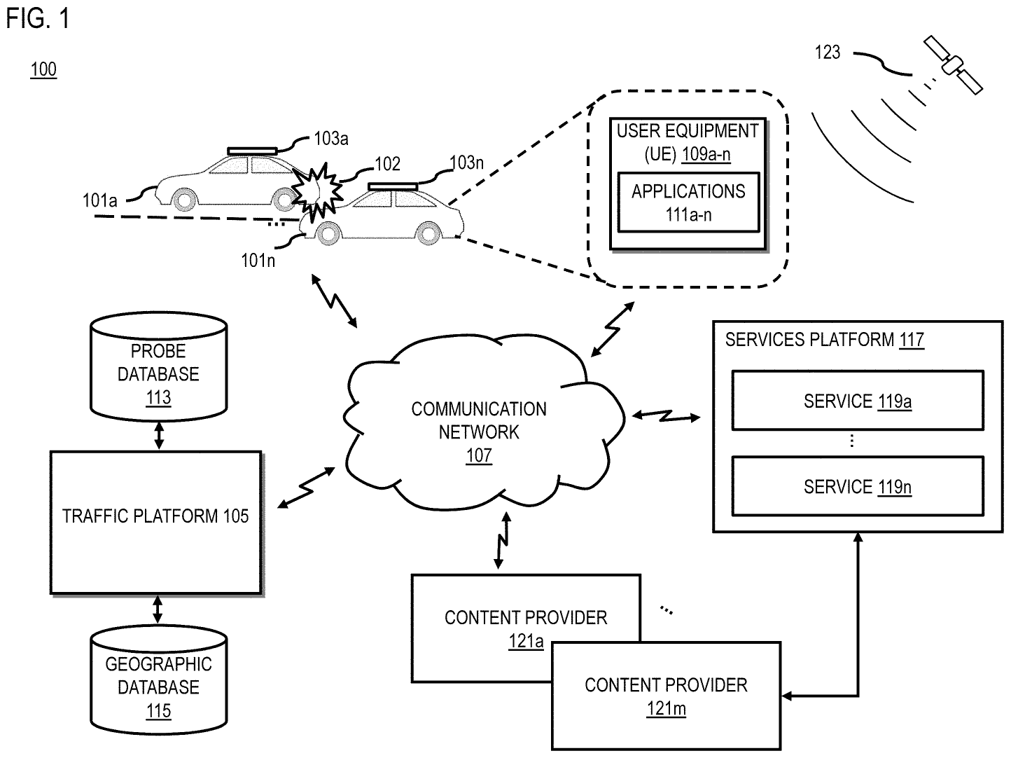

FIG. 1 is a diagram of a system capable of providing traffic based location referencing with offsets for road incident reporting (i.e., from predefined road segments), according to one embodiment. Providing autonomous or semi-autonomous vehicles with up-to-date data on traffic incidents can reduce congestion and improve safety on the road network. Traffic service providers report real-time incidents on a specific road segment and send warning messages to vehicles driving upstream ahead of incidents based on multiple input resources (e.g., local or community resources, service providers, regulators, etc.) using various location referencing schemes. A location reference infers a scheme to describe a location on earth, such as by geographic features like a road, build, park, driving route, flooding area, etc. By way of example, the TMC (Traffic Message Channel) displays traffic information such as traffic congestion, accidents, and roadworks on the map screens by receiving FM multiplex broadcasting via communications networks. In general, TMC codes (e.g., ISO 17572 series) references a node at intersection of a road network or a boundary between two road segments.

In addition to TMC location referencing specification, the Transport Protocol Experts Group (TPEG) develops methods of universal location referencing (ULR), geographic location referencing (GLR), OpenLR location referencing (OLR), etc. (in e.g., ISO 18234 and IS21219 series) for location referencing based on geo-coordinates (e.g., World Geodetic System 1984 (WGS84)), along with supplementary information like bearing, function of road class and other attributes for better location encoding and decoding performance on digital maps using map matching techniques to support automotive applications. These approaches are designed to make the solutions map-agnostic. Unlike TMC which is a predefined location reference scheme shared through a TMC table across all digital map or traffic service providers, ULR, GLR, OLR target map independent location references based on different location reference generation rules.

However, these location referencing schemes were not designed to support the newer highly automated applications or autonomous driving applications, and each location referencing scheme has its own advantages and disadvantages. For instance, TMC covers mainly on freeway and priority arterials. In addition, TMC codes are defined based on road segments instead of lane usages such that special use lanes and regular lanes share the same TMC code. In many scenarios, TMC is unable to differentiate special use lanes (e.g., high-occupancy-vehicle (HOV) lanes, high-occupancy-toll (HOT) lanes, reversible lanes, etc.) from regular lanes. As a result, it is difficult to deliver lane-level traffic information based only on the TMC location referencing scheme. Moreover, since the TMC code table is shared across map and traffic service providers and infrequently updated (e.g. months) to include new and improved roadways, it is difficult to align TMC location reference with high definition (HD) mapping data that provide centimeter-level or better accuracy of map features to meet the requirements of autonomous driving applications.

On the other hand, OLR, ULR, GLR, etc. overcome the shortcomings of TMC coverage issues based on location coordinates of the WGS84 reference system targeting the independence of digital maps from encoder and decoders limitations, yet susceptible to (SIPS resolution errors (e.g., 1-3 meters), encoder and decoder digit representation errors, etc. For example, OLR can calculate a 24-bit integer representation which leads to a coordinate resolution (“error”) of approximately 2.4 meter, such that the encoder and the decoder can use different maps thus causing map-matching issues for location referencing.

Accordingly, mapping service providers face significant technical challenges to improve the location referencing schemes for better road incident reporting accuracy and efficiency that support autonomous driving, etc.

To address these problems, the system 100 of FIG. 1 introduces a capability to provide traffic based location referencing with offsets for road incident reporting (i.e., from TMC links), by creating an aggregated road segment comprising a start location in a first road segment via a road segment boundary to an end location in an end road segment.

In one embodiment, the system 100 can report a road incident 102 referencing to an aggregated road segment (e.g., generated based on real time traffic data of lane connections, maneuver changes, etc.) together with HD map data, in place of referencing the road incident 102 to a length of at least the road segments under an existing location referring scheme (e.g., TMC). The system 100 thus improve the incident reporting quality for newer applications such as automatous driving. In one embodiment, a road incident reporting message can include including a type and location of a road incident, status, start and end time, criticality, tables, verified, and other relevant data.

By way of example, the system 100 can aggregate the underlying traffic conditions across at least one TMC link boundary based on the vehicle's driving lane path. The system 100 can combine both the TMC on a lane-level resolution with OLR location referencing advantages, thereby improving road incident encoder and decoder performance which is critical to support highly automated driving and autonomous driving.

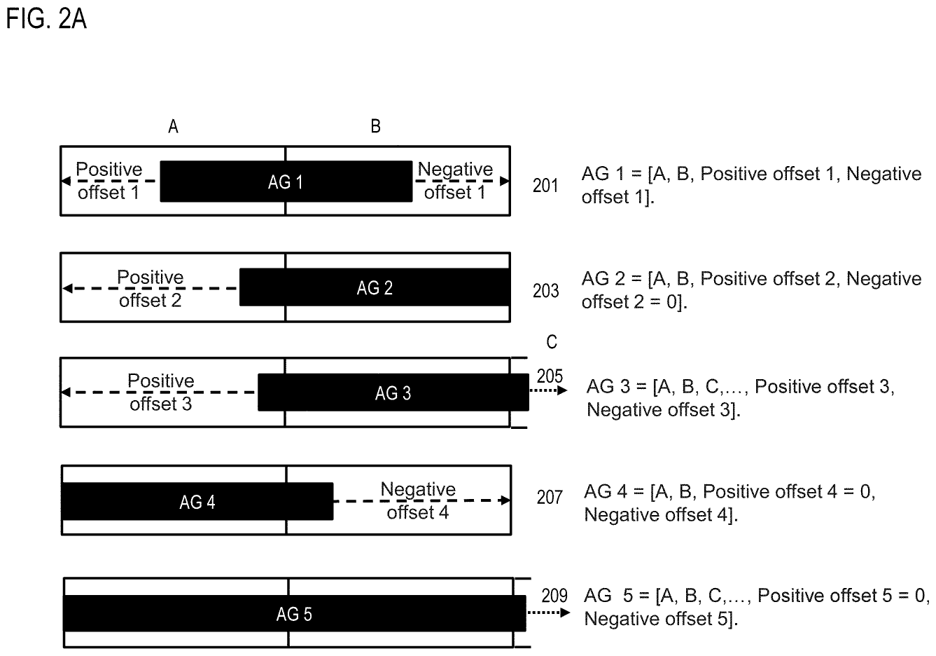

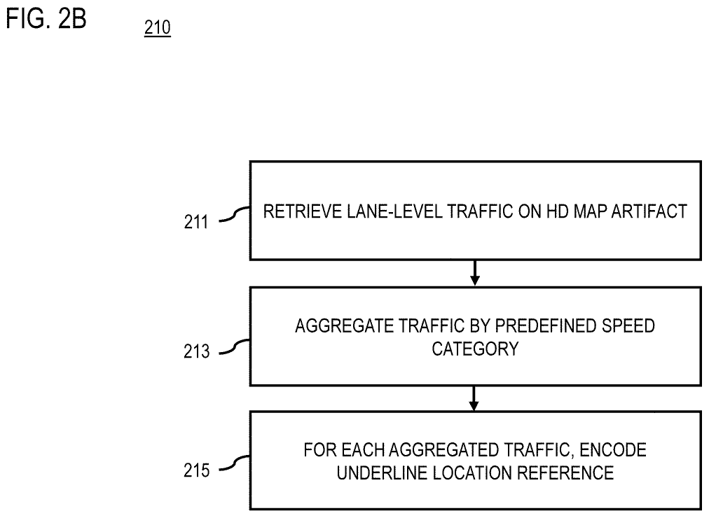

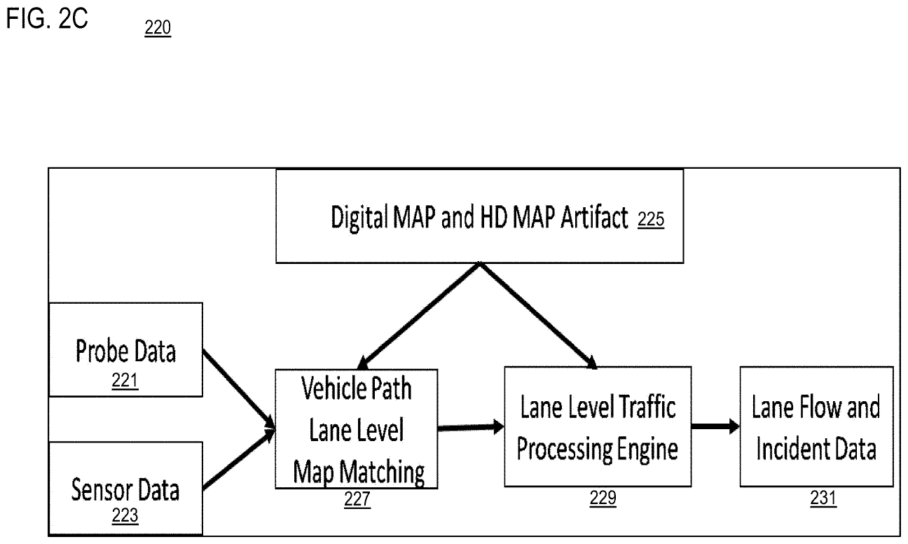

FIG. 2A are diagrams of example aggregated road segments, according to various embodiment. By way of example, a road incident is a vehicle crash that causes a congestion (e.g., TMC incident code X) extending from a road segment A (e.g., TMC link A) to a road segment B (e.g., TMC link B), status, start/end time, and other relevant data.

Taking a scenario 201 (i.e., the congestion covering the segments A and B partially) as an instance, instead of reporting a road incident (e.g., the road incident 102) as in road segments A and B under the TMC location referencing scheme as two instances: [A, incident code X, status, start/end time, etc.] and [B, incident code X, status, start/end time, etc.], the system 100 can report the same road incident referencing to an aggregated road segment AG1 as: [A, B, Positive offset 1, Negative offset 1] with an incident code X, status, start/end time, etc. The positive offset 1 is a distance from a location reference point (LRP) of the beginning of the road incident to the beginning of the road segment A, and the negative offset 1 is a distance from another LRP of the end of the road incident to the end of the road segment B. In this case, the system 100 can not only reduce the reporting instances but also more precisely referencing the beginning and the end of the road incident.

Similarly, in a scenario 203, the congestion starts after the beginning of the road segment A and ends at the end of the road segment B, the system 100 can report the road incident referencing to an aggregated road segment AG2 as [A, B, Positive offset 2, Negative offset 2=0] with an incident code X, status, start/end time, etc. The positive offset 2 is a distance from a LRP of the beginning of the road incident to the beginning of the road segment A, and the negative offset 2 is a distance (i.e., =0) from another LRP of the end of the road incident to the end of the road segment B.

In a scenario 205, the congestion starts after the beginning of the road segment A, extends via the road segment B and into a road segment C (and possibly one or more subsequent road segment(s)). The system 100 can report the road incident referencing to an aggregated road segment AG3 as [A, B, C, . . . , Positive offset 3, Negative offset 3] with an incident code X, status, start/end time, etc.]. The positive offset 3 is a distance from a LRP of the beginning of the road incident to the beginning of the road segment A, and the negative offset 3 is a distance from another LRP of the end of the road incident to the end of the road segment B. In these scenarios 203 and 205, the system 100 also can more precisely reference the beginning and the end of the road incident, and further reduce the number of reporting instances. For example, in the scenario 205, the road incident as in road segments A, B, C, . . . will be reported under the TMC location referencing scheme as instances: [A, incident code X, status, start/end time, etc.], [B, incident code X, status, start/end time, etc.], [C, incident code X, status, start/end time, etc.], . . . , etc.

The congestion starts from the beginning of the road segment A and extends into the road segment B in a scenario 207, and the congestion also starts from the beginning of the road segment A, via the road segment B and into the road segment C (and possibly further) in a scenario 209. By analogy, the system 100 can report the road incident referencing to an aggregated road segment AG4 as [A, B, Positive offset 4=0, Negative offset 4] with an incident code X, status, start/end time, etc., and an aggregated road segment AG5 as [A, B, C, . . . , Positive offset 5=0, Negative offset 5] with an incident code X, status, start/end time, etc. respectively.

It is noted that the term “road incident” refers to a traffic incident, a road configuration change instance (e.g., by a work area, an event (e.g., a parade), etc.), a road connection change (e.g., detouring), etc. A traffic incident can be any occurrence on a roadway that impedes normal traffic flow. For instances, traffic incidents include any recurring or non-recurring events that cause a reduction of roadway capacity or an abnormal increase in demand, such as traffic crashes, disabled vehicles, spilled cargo, highway maintenance and reconstruction projects, special non-emergency events (e.g., ball games, concerts, or any other event that significantly affects roadway operations), etc.

As the examples shown in FIG. 2A, the system 100 can reduce road incident reporting message sizes which better describes the state of the road incident (e.g., a congestion). In later described embodiments, the system 100 can represent multiple paths along the same road network that have differing levels of service, while eliminating non-value-added information from the data stream. In short, the system 100 can provide 2×-3× reduction in the number of TPEG vector sections without reducing the content quality, or even increasing the content quality with more precise location referencing points, e.g., for navigation, estimated times of arrival, supporting advanced driver-assistance systems (ADAS), etc.

FIG. 2B is a diagram of an example process 210 for providing traffic based location referencing with offsets for road incident reporting, according to one embodiment. In step 211, the system 100 can retrieve lane-level traffic data based on HD map artifact. FIG. 2C is a diagram of an example data flow 220 for providing traffic based location referencing using aggregated road segments, according to one embodiment. For instance, the system 100 can process probe data 221 and/or sensor data 223 for map-matching the data to one or more lane-level vehicle paths on a roadway based on digital map and HD map artifact 225, i.e., a vehicle path lane-level map-matching step 227.

The probe data 221 and/or the sensor data 223 may be recent or real-time depending on the data availability. For busy roads, there are sufficient real-time data points. On the other hand, for less used roads, the probe data 221 and/or the sensor data 223 can be collected recently (e.g., for a period of time).

The system 100 can use a lane level traffic processing engine 229 to extract real-time lane traffic flow and/or incident data 231 from the probe/sensor data. In one instance, the probe data may be reported as real-time probe points, which are individual data records collected at a point in time that records telemetry data for that point in time. A probe point can include attributes such as: (1) probe ID, (2) longitude, (3) latitude, (4) altitude, (5) heading, (6) speed, and (7) time.

By way of example, the lane level traffic processing engine 229 can extract speed data of probe points heading toward the same direction on a roadway at a current time point, and aggregate some of the probe points of the same speed range (e.g., a heavy congestion speed range of 0-1 mph) into a heavy congestion section on the roadway between a beginning location reference point (LRP) and an end LRP.

In step 213, the system 100 can aggregate the real-time lane traffic flow and/or incident data 231 by one or more predefined speed categories. For instance, the system 100 can aggregate underlying lane level traffic data across road segment boundaries per vehicle driving lane path. By way of example, such heavy congestion section can be an aggregated road segment (e.g., AG1 in the scenario 201) depicted in FIG. 2A. The heavy congestion can occur across all lanes of the roadway in that section, or just some lane(s) of the section.

For each aggregated traffic data set, the system 100 can encode underline location reference points (LRPs) in step 215. For instance, the beginning LRP of the heavy congestion section is referenced to the beginning of the road segment A with the positive offset 1, while the end LRP of the heavy congestion section is referenced to the end of the road segment B with the negative offset 1. The system 100 can report the heavy congestion section on the roadway as the aggregated road segment with a road incident code in a road incident message, such as [A, B, Positive offset 1, Negative offset 1, road incident code X, status, start/end time, etc.]. The message can be delivered to end users over air radio interfaces and/or internet. As such, the system 100 can utilize both the TMC road segment referencing scheme and the OLR location referencing to improve the road incident encoder and decoder performance, which can support highly automated driving and autonomous driving.

As a result, the system 100 can aggregate road incident information from various sources reported based on the hybrid (TMC/OLR) location referencing scheme, then use the hybrid location referencing incident data to dynamically optimize route calculations, etc. Moreover, the system 100 can output the hybrid location referencing incident data to better design road incident reporting and management strategies, such as assessing affected areas under the average and the worst incident scenarios, patrol vehicle distribution around freeway segments, identifying hazardous highway segments for safety and operations concerns, etc.

In one embodiment, the system 100 collects a plurality of instances of probe data, vehicle sensor data, and/or road incident information from one or more vehicles 101a-101n (also collectively referred to as vehicles 101) (e.g., autonomous vehicles, HAD vehicles, semi-autonomous vehicles, etc.) having one or more vehicle sensors 103a-103n (also collectively referred to as vehicle sensors 103) (e.g., global positioning system (GPS), LiDAR, camera sensor, etc.) and having connectivity to a traffic platform 105 via a communication network 107.

In one instance, the system 100 can also collect the real-time probe data, sensor data, and/or traffic incident information from one or more user equipment (UE) 109a-109n (also collectively referenced to herein as UEs 109) associated with the a vehicle 101 (e.g., an embedded navigation system), a user or a passenger of a vehicle 101 (e.g., a mobile device, a smartphone, etc.), or a combination thereof. In one embodiment, the system 100 can collect crowdsourced incident data that can include user-reported accidents, traffic jams, speed, and police traps, etc., via navigation and/or map applications such as Waze®, etc. In one instance, the UEs 109 may include one or more applications 111a-111n (also collectively referred to herein as applications 111) (e.g., a navigation or mapping application). In one embodiment, the probe data and/or sensor data collected may be stored in a probe database 113, a geographic database 115, or a combination thereof.

In one instance, the system 100 may also collect real-time probe data, sensor data, and/or traffic incident information from one or more other sources such as government/municipality agencies, local or community agencies (e.g., a police department), and/or third-party official/semi-official sources (e.g., a services platform 117, one or more services 119a-119n, one or more content providers 121a-121m (also collectively referred to herein as content providers 121), etc.). In one embodiment, the system 100 may collect the authority incident data that can include traffic incident feeds, traffic crash reports, police reports, etc. published by public authorities. In another embodiment, the system 100 can collect video monitoring incident data that can include traffic monitoring camera data, etc.

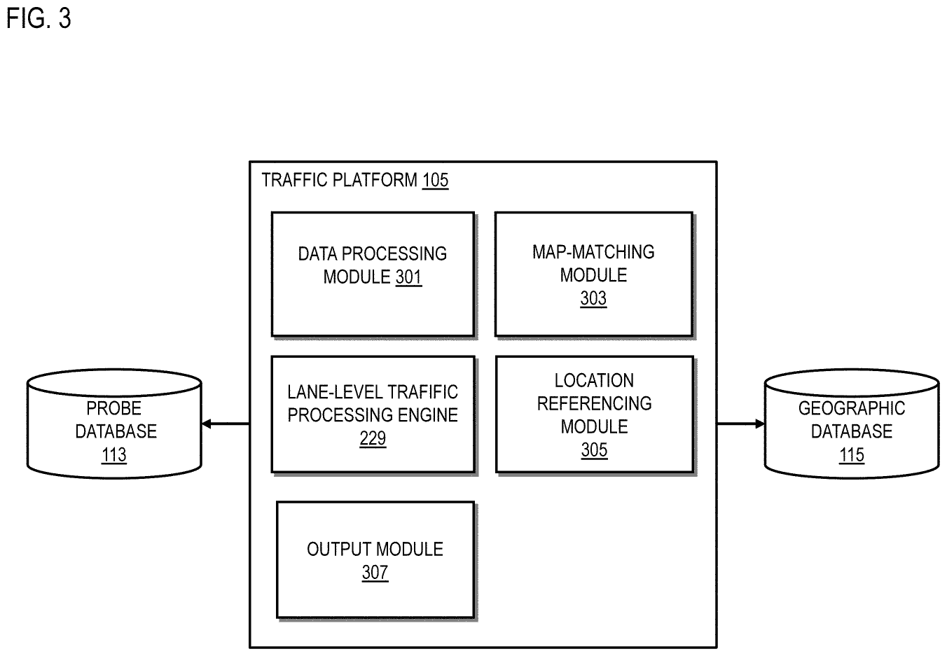

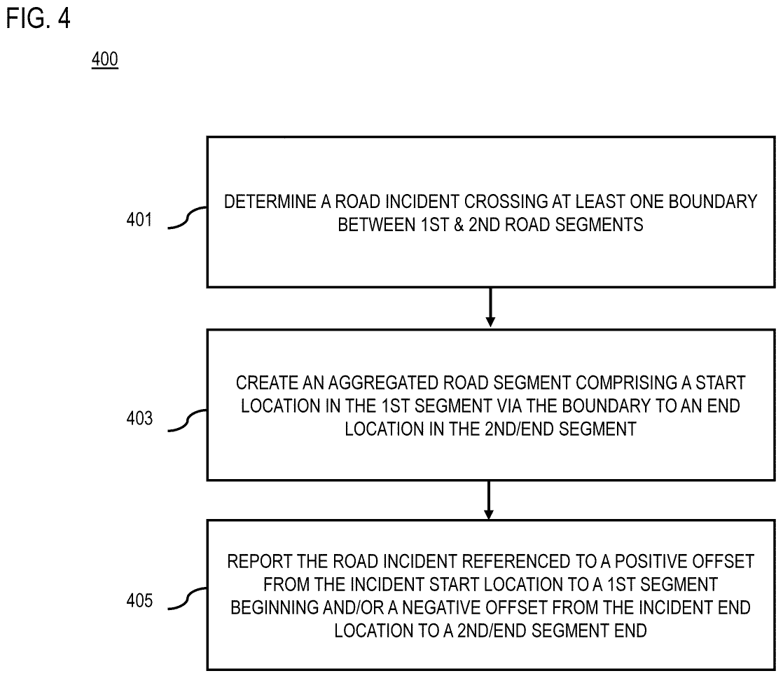

FIG. 3 is a diagram of the components of the traffic platform 105, according to one embodiment. By way of example, the traffic platform 105 includes one or more components for providing traffic based location referencing with offsets for road incident reporting, according to the various embodiments described herein. It is contemplated that the functions of these components may be combined or performed by other components of equivalent functionality. In one embodiment, the traffic platform 105 includes a data processing module 301, a map-matching module 303, a location referencing module 305, an output module 307, and the lane level traffic processing engine 229 with connectivity to the probe database 113 and the geographic database 115. The above presented modules and components of the traffic platform 105 can be implemented in hardware, firmware, software, or a combination thereof. Though depicted as a separate entity in FIG. 1, it is contemplated that the traffic platform 105 may be implemented as a module of any other component of the system 100. In another embodiment, the traffic platform 105, the lane level traffic processing engine 229, and/or the modules 301-307 may be implemented as a cloud-based service, local service, native application, or combination thereof. The functions of the traffic platform 105, the lane level traffic processing engine 229, and/or the modules 301-307 are discussed with respect to FIG. 4.

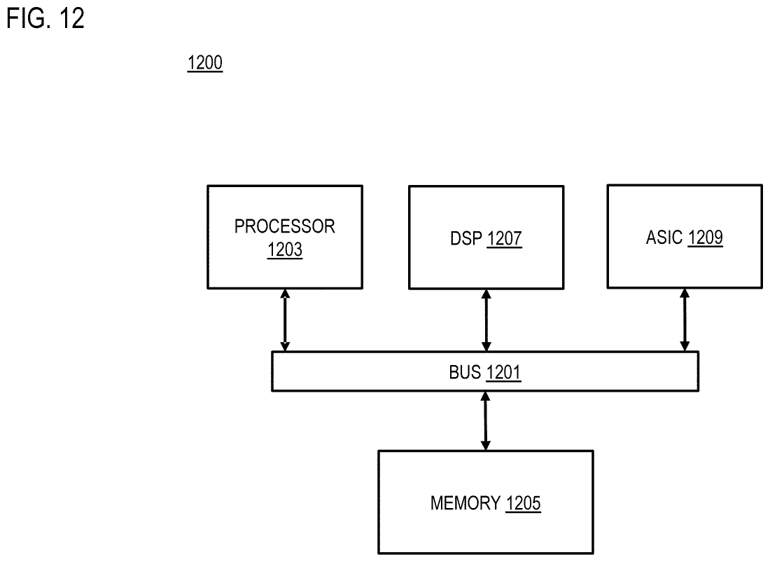

FIG. 4 is a flowchart of a process 400 for providing traffic based location referencing using aggregated road segments, according to one embodiment. In various embodiments, the traffic platform 105, the lane level traffic processing engine 229, and/or any of the modules 301-307 may perform one or more portions of the process 400 and may be implemented in, for instance, a chip set including a processor and a memory as shown in FIG. 12. As such, the traffic platform 105 and/or the modules 301-307 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

In one embodiment, the data processing module 301 can retrieve lane-level probe data, sensor data, or a combination thereof associated with the road segments. The map-matching module 303 can then map-match the lane-level probe data, sensor data, or a combination thereof to high-definition map data to determine a road incident (e.g., the road incident 102) at a lane-level.

In one embodiment, in step 401, the data processing module 301 can determine the road incident that crosses at least one boundary between a first road segment and a second road segment. By way of example, the road incident can be a traffic incident (e.g., a congestion), a road work, or a road connection (e.g., parallel road segments, a roadway change, etc.).

In one embodiment, in step 403, the location referencing module 305 can create an aggregated road segment comprising a start location of the road incident in the first road segment to the boundary and from the boundary to an end location of the road incident in the second road segment or an end road segment. In one embodiment, the road segments can be defined under a pre-coded location referencing scheme. By way of example, the pre-coded location referencing scheme is a traffic message channel (TMC) location referencing method

In one embodiment, the location referencing module 305 can determine a first LRP with the positive offset from the beginning of the first segment, when the first LRP is not located at the beginning. In another embodiment, the location referencing module 305 can insert one intermediate LRP in the first, second, or end road segment where (1) there is a difference of speed categories among different lanes of a respective road segment, (2) there is a difference of speed categories within the respective road segment or among two connected road segments, (3) there are parallel road segments located within a threshold distance and connecting between a pair of other road segments, (4) there is an aggregated road segment length of the at least first and second road segments exceeding a predefined total maximum length, (5) there is a roadway change, or a combination thereof. By way of example, the speed categories can include free flow, congestion, heavy congestion, or a combination thereof. In another embodiment, the location referencing module 305 can determine an end LRP with the negative offset from the end of the end segment, when the end LRP is not located at the end.

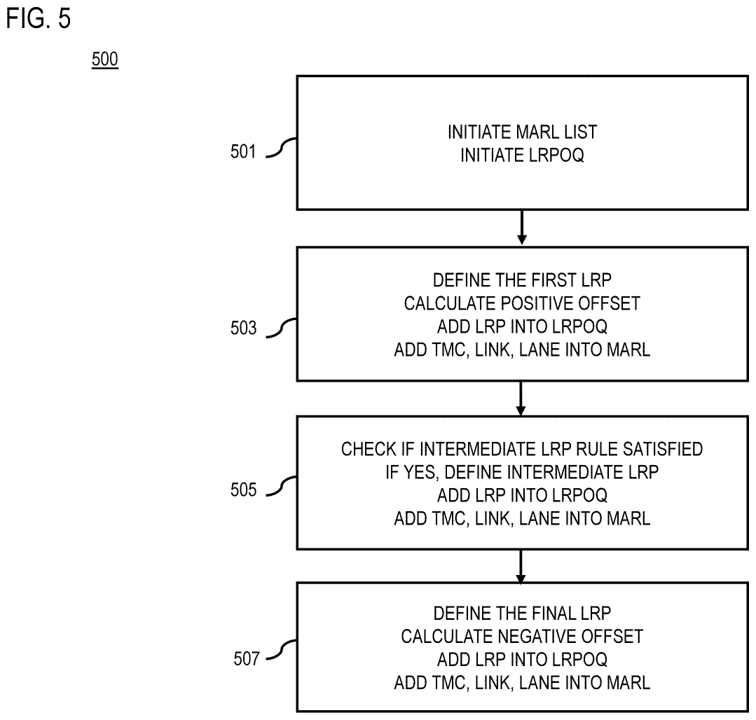

FIG. 5 is a flowchart of a process 500 for generating example location reference points (LRPs), according to various embodiments. The process 500 of steps 501-507 can be added into the process 210 and/or the process 400. In one embodiment, the lane level traffic processing engine 229 can work in conjunction with the data processing module 301 and the map-matching module 303 to determine real time traffic at a lane-level based on HP map data (e.g., the output of the lane level traffic processing in shown in FIG. 2C).

For instance, the location referencing module 305 can aggregate all lane level traffic on the same speed category (e.g.,, free flow, congestion, heavy congestion, etc.) together along a driving direction and the associated lane level road segments in an HD map. In this instance, all underline road segments corresponding to aggregated traffic can be connected. The location referencing module 305 can encode the underline road segments with location reference points (LRPs) based on the associated aggregated lane-level real time traffic according to the process 500.

In one embodiment, in step 501, the location referencing module 305 can initiate an empty map artifact road segment list (MARL). In addition the location referencing module 305 can initiate an empty location reference point object queue (LRPOQ).

In one embodiment, in step 503, the location referencing module 305 can define a first LRP at the beginning of the road segments. When the first LRP is no at the beginning of an associated TMC/Link/Lane, the location referencing module 305 can calculate a positive offset (e.g., with a resolution at centimeters), add the first LRP into the LRPOQ, and add the underline TMC/Link/Lane ID into the MARL.

In one embodiment, in step 505, the location referencing module 305 can check whether an intermediate LRP rule is satisfied. If yes, the location referencing module 305 can define an intermediate LRP, insert intermediate LRPs into the LRPOQ, and add the underline TMC/Link/Lane ID into the MARL. Example intermediate LRP rules can be adding an Intermediate LRP to the list of location reference points (1) when there exists a difference of traffic information (e.g., speed, direction, etc.) among different lanes on a TMC link or road segment, (2) when there exists parallel paths in connection to previous and next road segments and the distance(s) between these paths is within a certain range (e.g., two miles), (3) when an aggregated road segment length exceeds a predefined total maximum length (e.g., ten miles), (4) when there are major roadway changes such as from Highway XX to Highway YY, from Highway XX to an arterial road ZZ, etc., (5) when all lanes on the TMC link or road segment are within the same traffic speed category, etc.

In one embodiment, in step 507, the location referencing module 305 can define the final LRP at the end of road segments when the final LRP is not at the end of the TMC/Link/Lane, and add a negative offset (e.g., with a resolution of centimeters).

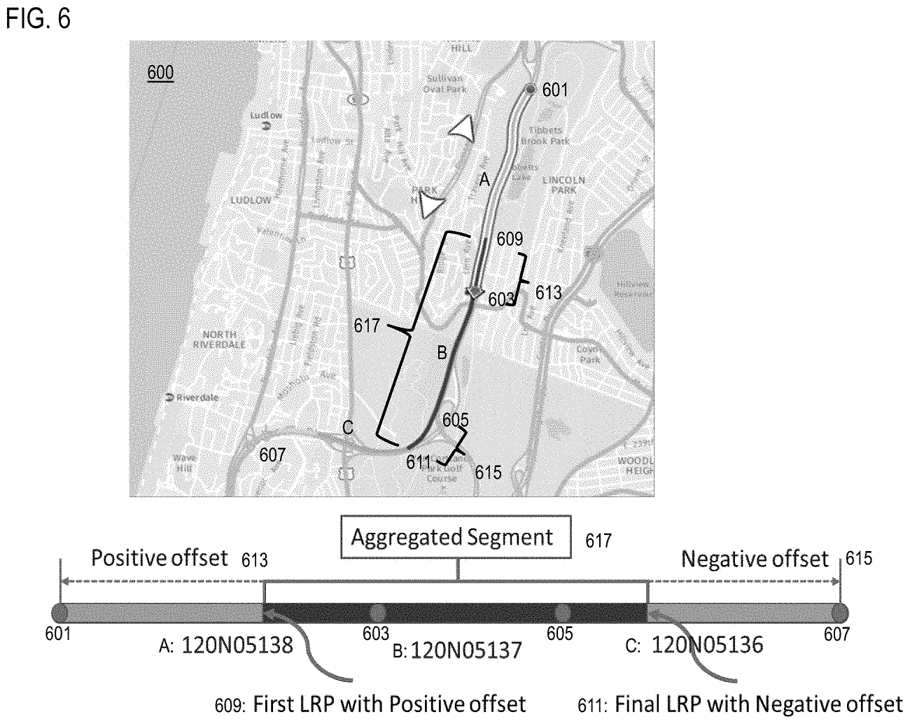

FIG. 6 is a diagram of an example scenario of traffic aggregation and location reference generation, according to one embodiment. In the scenario, the output module 307 can generate a map 600 such that it depicts three road segments: A: 120N05138, B3: 120N05137, C: 120N05136 separated by location points 601, 603, 605, 607 marked in dots. For instance, the driving direction is from road segment A via road segment B to rod segment C along a roadway. As shown in FIG. 6, only a part of segment A and a part of segment C are congested with traffic, while the segment B is fully congested. In this instance, the location referencing module 305 can aggregate all congestion traffic together, and then define a first location reference point 609 with a positive offset 613 from the beginning of the road segment A, as well as a final location reference point 611 with a negative offset 615 from the end of the road segment C. To simplify the discussion, the location referencing module 305 can assume traffic on all lanes on the roadway are the same. The location referencing module 305 can define an aggerated road segment 617 with the road segments A-C, and the two location reference points 609, 611, and generate a corresponding map artifact road segment list (MARL): [120N05138, 120N05137, 120N05136, Positive offset, Negative offset] that is associated with a road incident code for congestion.

In one embodiment, in step 405, the output module 307 can provide a report of the road incident that is referenced to a positive offset from the end location of the road incident to a beginning of the first road segment, a negative offset from the end location of the road incident to an end of the second road segment or the end road segment, or a combination thereof (in place of referencing a length of the aggregated road segment, e.g., the aggerated road segment 617). By way of example, the report can include the positive offset and the negative offset. The report can further include a road incident code, status, start and end time, criticality, tables, verified, and other relevant data. In one embodiment, the report can be provided at a link-level. In another embodiment, the report can be provided at a lane-level.

For instances, the report can be delivered in an extensible markup language (e.g., XML), an open standard file format (e.g., JSON), or a binary format. By way of example, LPR can be defined as in Table 1:

TABLE 1

```
LRP definition:
  <LRP>
      <coordinate>
        <longitude>−73.1567</longitude>
        <latitude>34.3886</latitude>
      <coordinate>
    <road>
      <functionclass> 1 </ functionclass>
      <bearing>179 </bearing>
      <dnp> 2150 </dnp>
      <lane> 3 </lane>
  </LRP>
```

Latitude : −90 degree to +90 degree

Longitude: −180 degree to +180 degree

Functionclass: FRC0-FRC5, or FRC0-FRC7 based on OLR definition.

Bearing: an angle between the true north and a line defined by the coordinate of the LR-point and a coordinate along a line defined by the LR-point, e.g., such line can be a TMC/Link/Lane along a driving direction.

DNP: a distance (e.g., with a resolution of centimeters) to next LRP. For instance, this value is 0 in LRP at the beginning/end of aggregated road segments.

Lane: from left to right along the driving direction, the lane index number. When all lanes of a link share the same traffic (e.g., the same speed category), this value is defined as −1.

In one embodiment, the output module 307 can publish the report in a geographic database (e.g., a road safety database, a real-time traffic reports RSS feed, the geographic database 115, etc.), a location-based service, or a combination thereof. By way of example, the location-based service is a navigation service, a traffic incident service, a package delivery service, a ride-hailing service, a ridesharing service, etc.

In another embodiment, the system 100 can determine a road incident comprising a start location and an end location within a road segment, create an sub-segment corresponding to the start location and the end location, and provide a report of the road incident that is referenced to a positive offset from the start location of the road incident to a beginning of the road segment and a negative offset from the end location of the road incident to an end of the road segment (in place of referencing a length of the sub-segment). For examples, the road incident can be a traffic incident, a road work, or a road connection.

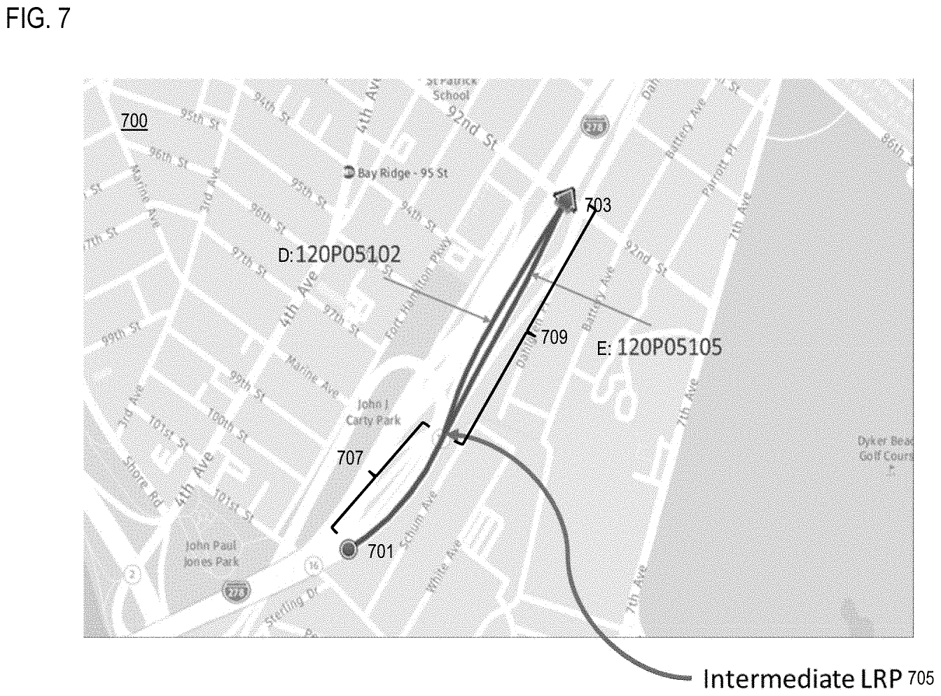

FIG. 7 is a diagram of an example scenario of traffic aggregation and location reference generation involving intermediate location reference point(s), according to one embodiment, In the scenario, the system 100 can generate a map 700 such that it depicts two road segments: D: 120P05102, E: 120P05105 between two location points 701, 703 marked in dots. For instance, the driving direction is from the location point 701 to the location point 703 along a roadway. As shown in FIG. 7, a part of segment D and a part of segment E are in parallel, which creates an ambiguous situation on the decoder side, so it is necessary to insert an intermediate LRP 705 at the split, In this instance, the intermediate LRP 705 has a positive offset 707 from the beginning of the road segments D, E (i.e., the location point 701), and a negative offset (i.e., equal to zero) from the end of the road segments D, E (i.e., the location point 703).

To simplify the discussion, the system 100 can assume traffic on all lanes on the roadway are the same. The system 100 can define an sub-segment 709 within the road segments D-E based on the intermediate LRP 705, and generate a corresponding map artifact road segment list (MARL): [120P05102, 120P05105, Positive offset, Negative offset] that is associated with a road incident code for parallel paths. In another scenario, the parallel paths start from the beginning points of the road segments D, F and end at one intermediate LRP before the end point of the road segments D, E. In yet another scenario, the parallel paths start from one intermediate LRP after the beginning points of the road segments D, E, and end at another intermediate LRP before the end point of the road segments D, E. In these scenarios, the system 100 can more precisely reference the beginning and the end of the road incident (e.g., parallel paths) to one or more intermediate LRPs.

In other embodiments, the road incident (e.g., parallel paths) can extend across one or more road segment boundaries similar to the aggerated road segments AG1-AG5 in FIG. 2A. In these scenarios, the system 100 not only more precisely references the beginning and the end of the road incident (e.g., parallel paths) to one or more LRPs, but also reduce the reporting instances.

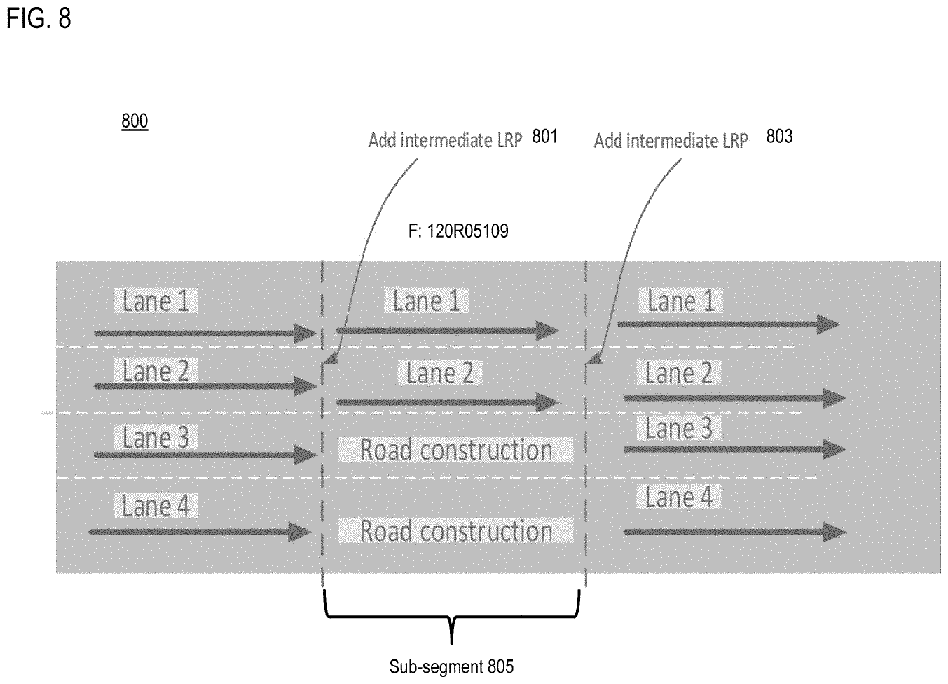

In another embodiment, a sub-segment is referenced at a lane-level. FIG. 8 is a diagram of an example scenario of traffic aggregation and location reference generation involving intermediate location reference point(s) at a lane-level, according to one embodiment. In the scenario, the system 100 can generate a road diagram 800 such that it depicts four lanes (Lane 1, Lane 2, Lane 3, Lane 4) in one road segment F: 120805109. For instance, the driving direction is from left to right along a roadway. The road construction event causes a 4-lane road changing to 2-lane. In such case, since both the traffic and its corresponding location references have been changed, the system 100 can add two intermediate LRPs: one before the road construction event and one after the road construction event. As shown in FIG. 8, a part of Lane 3 and a part of Lane 4 are restricted by a road construction event, so it is necessary to insert intermediate LRPs 801, 803 at the beginning and the end of the road construction event. In this instance, the intermediate LRP 801 has a positive offset from the beginning of the road segments F (not shown), and the intermediate LRP 803 has a negative offset from the end of the road segment F (not shown).

The system 100 can define a sub-segment 805 within the road segment F based on the intermediate LRPs 801, 803, and generate a corresponding map artifact road segment list (MARL): [120R05109, Lane 3, Lane 4, Positive offset, Negative offset] that is associated with a road incident code for road construction. In another scenario, the road construction event starts from the beginning point of the road segment F and end at one intermediate LRP before the end point of the road segment F. In yet another scenario, the road construction event starts from one intermediate LRP after the beginning point of the road segment F, and end at the end point of the road segment F. In these scenarios, the system 100 can more precisely referencing the beginning and the end of the road incident (e.g., a road construction event) to one or more intermediate LRPs.

In other embodiments, the road incident (e.g., a road construction event) can extend across one or more road segment boundaries similar to the aggerated road segments AG1-AG5 in FIG. 2A. For instance, the road incident can extend from the first road segment, via the second road segment, . . . , and into the end road segment, e.g., there may be zero or more road segments between the first road segment and the end road segment. The aggregation across those intermediate segments occurs as described below can reference with accuracy using (1) a positive offset from a start location of the road incident to a beginning of the first road segment, and (2) a negative offset from an end location of the road incident to an end of the end road segment. In these scenarios, the system 100 not only more precisely references the beginning and the end of the road incident (e.g., a road construction event) to one or more LRPs, but also reduce the reporting instances.

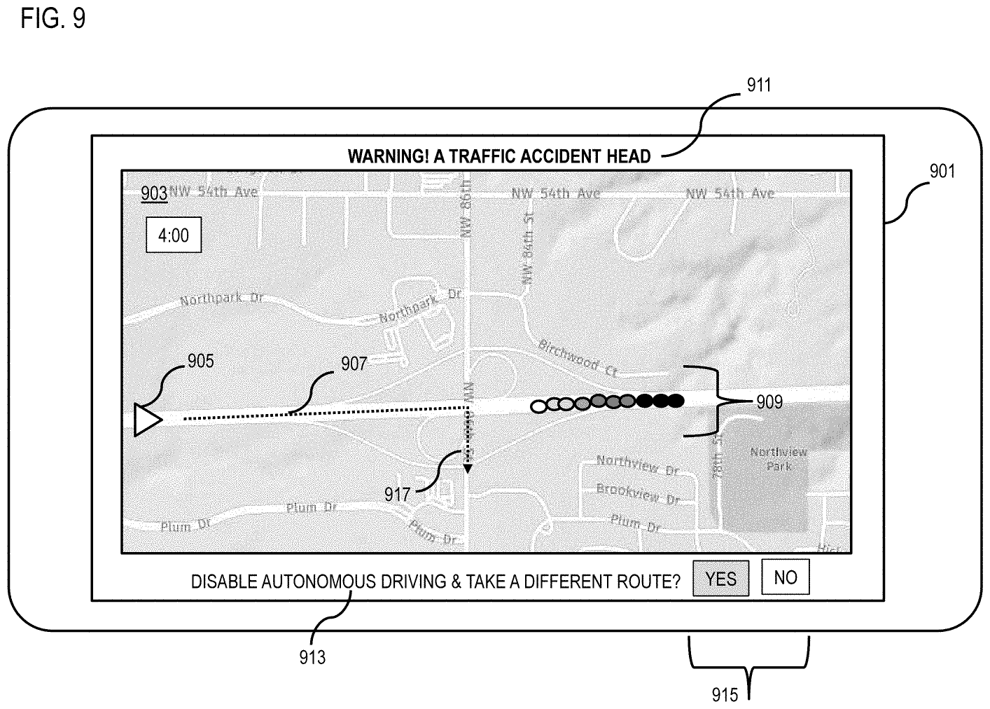

FIG. 9 is a diagram of an example user interface utilized real-time traffic based location referencing with offsets, according to one or more example embodiments. In FIG. 9, in one embodiment, the system 100 can generate a user interface (UI) 901 for a vehicle 101 and/or a UE 109 (e.g., a mobile device with applications 111 that can enable navigation, etc. In one instance, the system 100 can generate the UI 901 such that it includes a map 903. For instance, the map 903 can depict a vehicle 905 (e.g., the vehicle 101) carrying a user along a path 907 taken by the vehicle 905. Upon receiving a report of a road incident 909 (e.g., a traffic accident) occurring on the path 907, the system 100 can generate the UI 901 such that it includes an alert 911: “Warning! A traffic accident ahead”, and a query 913: “ Disable automatous driving and take a different route?” The system 100 can receive a user selection of an input 915 with two buttons (e.g., “Yes” and “No”) to determine whether to switch out of autonomous driving and detour from the traffic accident. In addition, the system 100 can further generate the UI 901 such that it includes an alternative route 917.

Returning to FIG. 1, in one embodiment, the traffic platform 105 has connectivity over the communication network 107 to the services platform 117 (e.g., an OEM platform) that provides one or more services 119 (e.g., probe and/or sensor data collection services). By way of example, the services 119 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 117 uses the output (e.g. lane-level dangerous slowdown event detection and messages) of the traffic platform 105 to provide services such as navigation, mapping, other location-based services, etc.

In one embodiment, the traffic platform 105 may be a platform with multiple interconnected components. The traffic platform 105 may include multiple servers, intelligent networking devices, computing devices, components, and corresponding software for providing parametric representations of lane lines. In addition, it is noted that the traffic platform 105 may be a separate entity of the system 100, a part of the services platform 117, a part of the one or more services 119, or included within the vehicles 101 (e.g., an embedded navigation system).

In one embodiment, content providers 121 may provide content or data (e.g., including probe data, sensor data, etc.) to the traffic platform 105, the UEs 109, the applications 111, the probe database 113, the geographic database 115, the services platform 117, the services 119, and the vehicles 101. The content provided may be any type of content, such as map content, textual content, audio content, video content, image content, etc. In one embodiment, the content providers 121 may provide content that may aid in localizing a vehicle path or trajectory on a lane of a digital map or link. In one embodiment, the content providers 121 may also store content associated with the traffic platform 105, the probe database 113, the geographic database 115, the services platform 117, the services 119, and/or the vehicles 101. In another embodiment, the content providers 121 may manage access to a central repository of data, and offer a consistent, standard interface to data, such as a repository of the geographic database 115.

By way of example, the UEs 109 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 109 can support any type of interface to the user (such as “wearable” circuitry, etc.). In one embodiment, a UE 109 may be associated with a vehicle 101 (e.g., a mobile device) or be a component part of the vehicle 101 (e.g., an embedded navigation system). In one embodiment, the UEs 109 may include the traffic platform 105 to provide traffic based location referencing with offsets for road incident reporting.

In one embodiment, as mentioned above, the vehicles 101, for instance, are part of a probe-based system for collecting probe data and/or sensor data for detecting traffic incidents (e.g., dangerous slowdown events) and/or measuring traffic conditions in a road network. In one embodiment, each vehicle 101 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, (4) altitude, (5) heading, (6) speed, and (7) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 101 may include sensors 103 for reporting measuring and/or reporting attributes. The attributes can also be any attribute normally collected by an on-board diagnostic (OBD) system of the vehicle 101, and available through an interface to the OBD system (e.g., OBD II interface or other similar interface).

The probe points can be reported from the vehicles 101 in real-time, in batches, continuously, or at any other frequency requested by the system 100 over, for instance, the communication network 107 for processing by the traffic platform 105. The probe points also can be map matched to specific road links stored in the geographic database 115. In one embodiment, the system 100 (e.g., via the traffic platform 105) can generate probe traces (e.g., vehicle paths or trajectories) from the probe points for an individual probe so that the probe traces represent a travel trajectory or vehicle path of the probe through the road network.

In one embodiment, as previously stated, the vehicles 101 are configured with various sensors (e.g., vehicle sensors 103) for generating or collecting probe data, sensor data, related geographic/map data, etc. In one embodiment, the sensed data represents sensor data associated with a geographic location or coordinates at which the sensor data was collected. In one embodiment, the probe data (e.g., stored in the probe database 113) includes location probes collected by one or more vehicle sensors 103. By way of example, the vehicle sensors 103 may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 101, switch sensors for determining whether one or more vehicle switches are engaged, and the like. Though depicted as automobiles, it is contemplated the vehicles 101 can be any type of vehicle manned or unmanned (e.g., cars, trucks, buses, vans, motorcycles, scooters, drones, etc.) that travel through road segments of a road network.

Other examples of sensors 103 of the vehicle 101 may include light sensors, orientation sensors augmented with height sensors and acceleration sensor (e.g., an accelerometer can measure acceleration and can be used to determine orientation of the vehicle), tilt sensors to detect the degree of incline or decline of the vehicle 101 along a path of travel (e.g., while on a hill or a cliff), moisture sensors, pressure sensors, etc. In a further example embodiment, sensors 103 about the perimeter of the vehicle 101 may detect the relative distance of the vehicle 101 from a physical divider, a lane line of a link or roadway, the presence of other vehicles, pedestrians, traffic lights, potholes and any other objects, or a combination thereof. In one scenario, the vehicle sensors 103 may detect weather data, traffic information, or a combination thereof. In one embodiment, the vehicles 101 may include GPS or other satellite-based receivers 103 to obtain geographic coordinates from satellites 123 for determining current location and time. Further, the location can be determined by visual odometry, triangulation systems such as A-GPS, Cell of Origin, or other location extrapolation technologies.

In one embodiment, the UEs 109 may also be configured with various sensors (not shown for illustrative convenience) for acquiring and/or generating probe data and/or sensor data associated with a vehicle 101, a driver, other vehicles, conditions regarding the driving environment or roadway, etc. For example, such sensors may be used as GPS receivers for interacting with the one or more satellites 123 to determine and track the current speed, position, and location of a vehicle 101 travelling along a link or roadway. In addition, the sensors may gather tilt data (e.g., a degree of incline or decline of the vehicle during travel), motion data, light data, sound data, image data, weather data, temporal data and other data associated with the vehicles 101 and/or UEs 109. Still further, the sensors may detect local or transient network and/or wireless signals, such as those transmitted by nearby devices during navigation of a vehicle along a roadway (Li-Fi, near field communication (NFC)) etc.

It is noted therefore that the above described data may be transmitted via communication network 107 as probe data (e.g., GPS probe data) according to any known wireless communication protocols. For example, each UE 109, application 111, user, and/or vehicle 101 may be assigned a unique probe identifier (probe ID) for use in reporting or transmitting said probe data collected by the vehicles 101 and/or UEs 109. In one embodiment, each vehicle 101 and/or UE 109 is configured to report probe data as probe points, which are individual data records collected at a point in time that records telemetry data.

In one embodiment, the traffic platform 105 retrieves aggregated probe points gathered and/or generated by the vehicle sensors 103 and/or the UE 109 resulting from the travel of the UEs 109 and/or vehicles 101 on a road segment of a road network. In one instance, the probe database 113 stores a plurality of probe points and/or trajectories generated by different vehicle sensors 103, UEs 109, applications 111, vehicles 101, etc. over a period while traveling in a monitored area. A time sequence of probe points specifies a trajectory—i.e., a path traversed by a UE 109, application 111, vehicle 101, etc. over the period.

In one embodiment, the communication network 107 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the vehicles 101, vehicle sensors 103, traffic platform 105, UEs 109, applications 111, services platform 117, services 119, content providers 121, and/or satellites 123 communicate with each other and other components of the system 100 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI reference model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

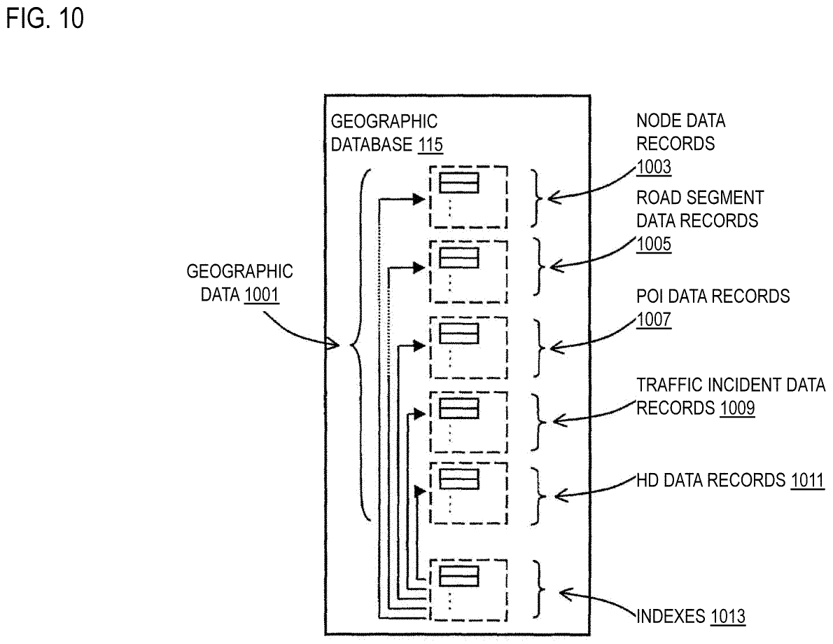

FIG. 10 is a diagram of a geographic database (such as the database 115), according to one embodiment. In one embodiment, the geographic database 115 includes geographic data 1001 used for (or configured to be compiled to be used for) mapping and/or navigation-related services, such as for video odometry based on the parametric representation of lanes include, e.g., encoding and/or decoding parametric representations into lane lines. In one embodiment, the geographic database 115 include high resolution or high definition (HD) mapping data that provide centimeter-level or better accuracy of map features. For example, the geographic database 115 can be based on Light Detection and Ranging (LiDAR) or equivalent technology to collect billions of 3D points and model road surfaces and other map features down to the number lanes and their widths. In one embodiment, the mapping data (e.g., mapping data records 1011) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 115.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 115 follows certain conventions. For example, links do not cross themselves and do not cross each other except at a node. Also, there are no duplicated shape points, nodes, or links. Two links that connect each other have a common node. In the geographic database 115, overlapping geographic features are represented by overlapping polygons. When polygons overlap, the boundary of one polygon crosses the boundary of the other polygon. In the geographic database 115, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 115 includes node data records 1003, road segment or link data records 1005, POI data records 1007, road incident data records 1009, mapping data records 1011, and indexes 1013, for example. More, fewer or different data records can be provided. In one embodiment, additional data records (not shown) can include cartographic (“carto”) data records, routing data, and maneuver data. In one embodiment, the indexes 1013 may improve the speed of data retrieval operations in the geographic database 115. In one embodiment, the indexes 1013 may be used to quickly locate data without having to search every row in the geographic database 115 every time it is accessed. For example, in one embodiment, the indexes 1013 can be a spatial index of the polygon points associated with stored feature polygons.

In exemplary embodiments, the road segment data records 1005 are links or segments representing roads, streets, or paths, as can be used in the calculated route or recorded route information for determination of one or more personalized routes. The node data records 1003 are end points corresponding to the respective links or segments of the road segment data records 1005. The road link data records 1005 and the node data records 1003 represent a road network, such as used by vehicles, cars, and/or other entities. Alternatively, the geographic database 115 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 115 can include data about the POIs and their respective locations in the POI data records 1007. The geographic database 115 can also include data about places, such as cities, towns, or other communities, and other geographic features, such as bodies of water, mountain ranges, etc. Such place or feature data can be part of the POI data records 1007 or can be associated with POIs or POI data records 1007 (such as a data point used for displaying or representing a position of a city).

In one embodiment, the geographic database 115 can also include the road incident data records 1009 for road incident data, real-time lane traffic flow and/or incident data, location reference point data, location reference point object queue (LRPOQ) data, offset data, map artifact road segment list (MARL) data, aggregated road segment data, sub-segment data, prediction models, annotated observations, computed featured distributions, sampling probabilities, and/or any other data generated or used by the system 100 according to the various embodiments described herein. By way of example, the road incident data records 1009 can be associated with one or more of the node records 1003, road segment records 1005, and/or POI data records 1007 to support localization or visual odometry based on the features stored therein and the corresponding estimated quality of the features. In this way, the road incident data records 1009 can also be associated with or used to classify the characteristics or metadata of the corresponding records 1003, 1005, and/or 1007.

In one embodiment, as discussed above, the mapping data records 1011 model road surfaces and other map features to centimeter-level or better accuracy. The mapping data records 1011 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 1011 are divided into spatial partitions of varying sizes to provide mapping data to vehicles 101 and other end user devices with near real-time speed without overloading the available resources of the vehicles 101 and/or devices (e.g., computational, memory, bandwidth, etc. resources).

In one embodiment, the mapping data records 1011 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 1011.

In one embodiment, the mapping data records 1011 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data also at centimeter-level accuracy. Other sensor data can include vehicle telemetry or operational data such as windshield wiper activation state, braking state, steering angle, accelerator position, and/or the like.

In one embodiment, the geographic database 115 can be maintained by the content provider 121 in association with the services platform 117 (e.g., a map developer). The map developer can collect geographic data to generate and enhance the geographic database 115. There can be different ways used by the map developer to collect data. These ways can include obtaining data from other sources, such as municipalities or respective geographic authorities. In addition, the map developer can employ field personnel to travel by vehicle (e.g., vehicles 101 and/or user terminals 109) along roads throughout the geographic region to observe features and/or record information about them, for example. Also, remote sensing, such as aerial or satellite photography, can be used.

The geographic database 115 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or a user terminal 109, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing traffic based location referencing with offsets for road incident reporting may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

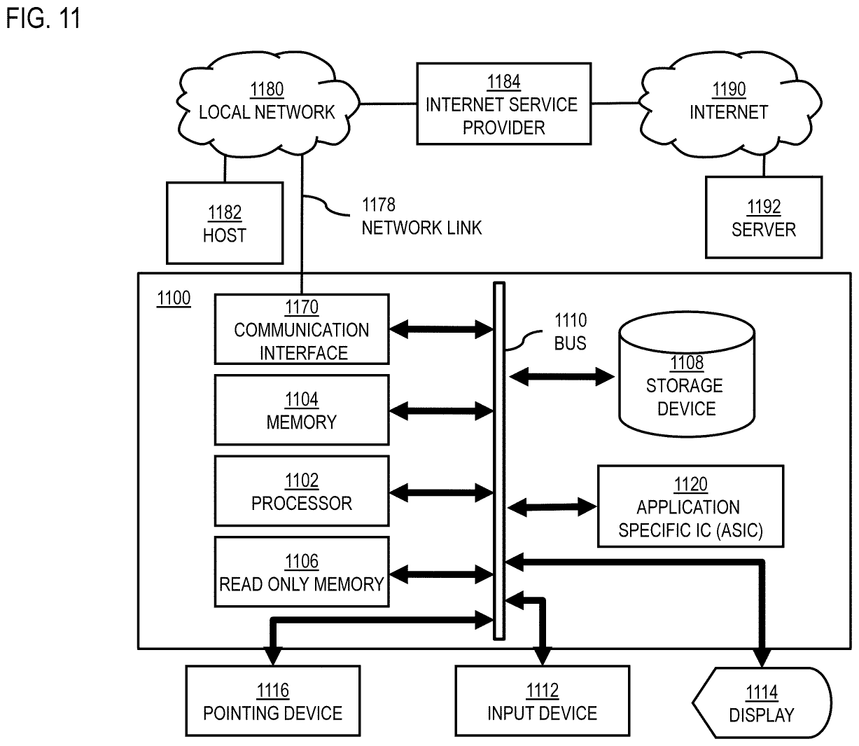

FIG. 11 illustrates a computer system 1100 upon which an embodiment of the invention may be implemented. Computer system 1100 is programmed (e.g., via computer program code or instructions) to provide traffic based location referencing with offsets for road incident reporting as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to providing traffic based location referencing with offsets for road incident reporting. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or other dynamic storage device, stores information including processor instructions for providing traffic based location referencing with offsets for road incident reporting. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for providing traffic based location referencing with offsets for road incident reporting, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 107 for providing traffic based location referencing with offsets for road incident reporting to the vehicles 101 and/or the UE 109.

The term computer-readable medium is used herein to refer to any medium that participates in providing information to processor 1102, including instructions for execution. Such a medium may take many forms, including, but not limited to, non-volatile media, volatile media and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system can be deployed in various configurations within other computer systems, e.g., host 1182 and server 1192.

FIG. 12 illustrates a chip set 1200 upon which an embodiment of the invention may be implemented. Chip set 1200 is programmed to provide traffic based location referencing with offsets for road incident reporting as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to provide traffic based location referencing with offsets for road incident reporting. The memory 1205 also stores the data associated with or generated by the execution of the inventive steps.

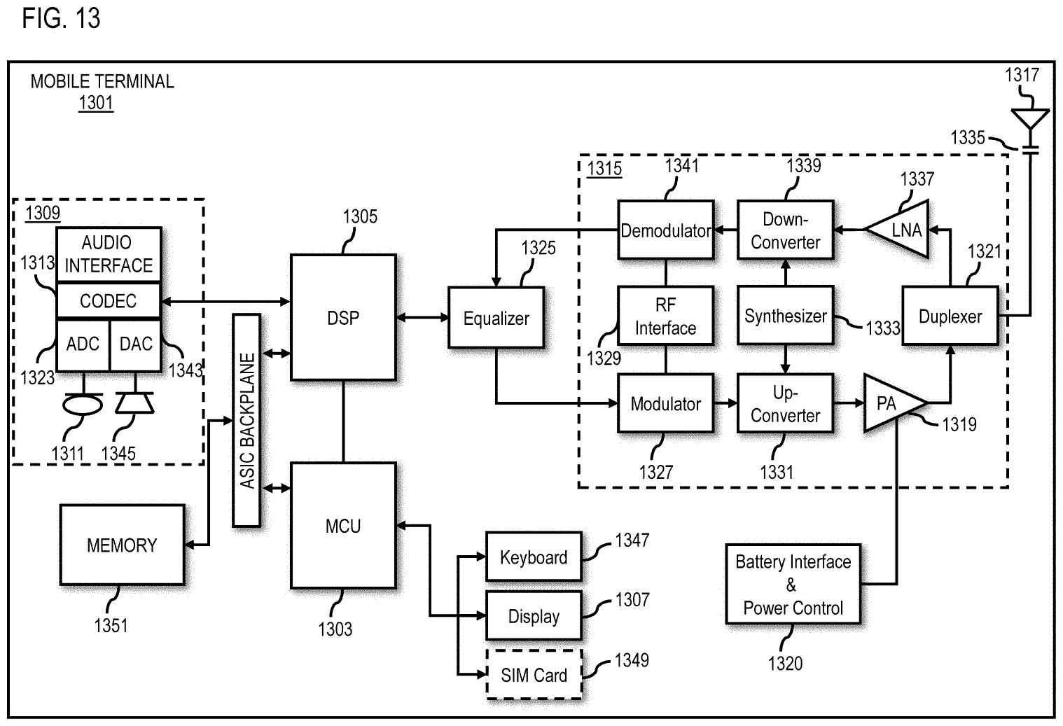

FIG. 13 is a diagram of exemplary components of a mobile terminal 1301 (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions that offer automatic contact matching. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile station 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303—which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile station 1301 to provide traffic based location referencing with offsets for road incident reporting. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile station 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1351 may be, but not limited to, a single memory, CD, DVD, ROM, RAM, EEPROM, optical storage, or any other non-volatile or non-transitory storage medium capable of storing digital data.

An optionally incorporated SIM card 1349 carries, for instance, important information, such as the cellular phone number, the carrier supplying service, subscription details, and security information. The SIM card 1349 serves primarily to identify the mobile station 1301 on a radio network. The card 1349 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining a road incident that crosses at least one boundary between a first road segment and a second road segment;
creating an aggregated road segment comprising a start location of the road incident in the first road segment to the boundary and from the boundary to an end location of the road incident in the second road segment or an end road segment; and
providing a report of the road incident that is referenced to a positive offset from the start location of the road incident to a beginning of the first road segment, a negative offset from the end location of the road incident to an end of the second road segment or the end road segment, or a combination thereof.

2. The method of claim 1, wherein the road incident is a traffic incident, a road work, or a road connection.

3. The method of claim 1, further comprising at least one of:
determining a first LRP with the positive offset from the beginning of the first segment, when the first LRP is not located at the beginning;
inserting one intermediate LRP in the first, second, or end road segment where (1) there is a difference of speed categories among different lanes of a respective road segment, (2) there is a difference of speed categories within the respective road segment or among two connected road segments, (3) there are parallel road segments located within a threshold distance and connecting between a pair of other road segments, (4) there is an aggregated road segment length of the at least first and second road segments exceeding a predefined total maximum length, (5) there is a roadway change, or a combination thereof; and
determining an end LRP with the negative offset from the end of the second road segment or the end segment, when the end LRP is not located at the end.

4. The method of claim 1, wherein the report includes the positive offset and the negative offset.

5. The method of claim 3, wherein the speed categories include free flow, congestion, heavy congestion, or a combination thereof.

6. The method of claim 1, further comprising:
retrieving lane-level probe data, sensor data, or a combination thereof associated with the road segments; and
map-matching the lane-level probe data, sensor data, or a combination thereof to high-definition map data to determine the road incident at a lane-level.

7. The method of claim 6, wherein the report is provided at a lane-level.

8. The method of claim 1, further comprising:
delivering the report in an extensible markup language, an open standard file format, or a binary format.

9. The method of claim 1, wherein the road segments are defined under a pre-coded location referencing scheme.

10. The method of claim 9, wherein the pre-coded location referencing scheme is a traffic message channel location referencing method.

11. The method of claim 1, further comprising:
publishing the report in a geographic database, a location-based service, or a combination thereof.

12. An apparatus comprising:
at least one processor; and
at least one memory including computer program code for one or more programs,
the at least one memory and the computer program code configured to, with the at least one processor, cause the apparatus to perform at least the following,
determine a road incident that crosses at least one boundary between a first road segment and a second road segment;
create an aggregated road segment comprising a start location of the road incident in the first road segment to the boundary and from the boundary to an end location of the road incident in the second road segment or an end road segment; and
provide a report of the road incident that is referenced to a positive offset from the start location of the road incident to a beginning of the first road segment, a negative offset from the end location of the road incident to an end of the second road segment or the end road segment, or a combination thereof.

13. The apparatus of claim 12, wherein the road incident is a traffic incident, a road work, or a road connection.

14. The apparatus of claim 12, wherein the apparatus is further caused to perform at least one of:
determining a first LRP with the positive offset from the beginning of the first segment, when the first LRP is not located at the beginning;
inserting one intermediate LRP in the first, second, or end road segment where (1) there is a difference of speed categories among different lanes of a respective road segment, (2) there is a difference of speed categories within the respective road segment or among two connected road segments, (3) there are parallel road segments located within a threshold distance and connecting between a pair of other road segments, (4) there is an aggregated road segment length of the at least first and second road segments exceeding a predefined total maximum length, (5) there is a roadway change, or a combination thereof; and
determining an end LRP with the negative offset from the end of the second road segment or the end segment, when the end LRP is not located at the end.

15. The apparatus of claim 12, wherein the apparatus is further caused to perform:
retrieve lane-level probe data, sensor data, or a combination thereof associated with the road segments; and
map-match the lane-level probe data, sensor data, or a combination thereof to high-definition map data to determine the road incident at a lane-level.

16. The apparatus of claim 15, wherein the report is provided at a lane-level.

17. The apparatus of claim 12, wherein the apparatus is further caused to perform:
deliver the report in an extensible markup language, an open standard file format, or a binary format.

18. A computer readable storage medium including one or more sequences of one or more instructions which, when executed by one or more processors, cause an apparatus to at least perform:
determining a road incident comprising a start location and an end location within a road segment;
creating an sub-segment corresponding to the start location and the end location; and
providing a report of the road incident that is referenced to a positive offset from the start location of the road incident to a beginning of the road segment, a negative offset from the end location of the road incident to an end of the road segment, or a combination thereof.

19. The computer readable storage medium of claim 18, wherein the road incident is a traffic incident, a road work, or a road connection.

20. The computer readable storage medium of claim 18, wherein the report is provided at a lane-level.
